(19) United States
(12) Patent Application Publication
(10) Pub. No.: US 2017/0361186 A1
(43) Pub. Date: Dec. 21, 2017

(54) Trash Tender

(71) Applicant: Mark Theodore Wolters, Encino, CA (US)

(72) Inventor: Mark Theodore Wolters, Encino, CA (US)

(21) Appl. No.: 15/625,322

(22) Filed: Jun. 16, 2017

Related U.S. Application Data
(60) Provisional application No. 62/350,953, filed on Jun. 16, 2016.

(51) Int. Cl. A63B 63/00; A63B 67/06; A63B 63/08; B65F 1/14

(52) U.S. Cl. CPC A63B 63/004; B65F 1/14; A63B 67/06; A63B 63/008; A63B 63/08; A63B 2209/10

(57) ABSTRACT

Waste basket basketball hoops are common and are enjoyed by many people, young and old. Waste basket basketball hoops can make cleaning up a fun activity. However, waste basket basketball hoops are usually affixed separately to the wall and not affixed to the waste basket. Further, there is no device that mimics other sport goals.

This device allows sports fans to use a waste basket sports goal for a sport other than basketball. This device is affixed directly to the waste basket.

### CROSS-REFERENCE TO RELATED APPLICATIONS

Provisional Patent Application No. 62/350,953, filed by Mark Wolters on Jun. 6, 2016.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

A basketball hoop has previously been used as a target for items tossed into a waste basket. People of all ages can enjoy trying to ‘score’ while cleaning up at the same time. However, scoring targets from other sports haven't been used in this manner. This device offers the user the opportunity to create a sports-style goal onto a waste basket, thereby allowing the user to ‘score’ by tossing trash into the waste basket through the goal.

### BRIEF SUMMARY OF THE INVENTION

This device uses the goal targets from sports, including hockey, soccer and football, to create a defined target area for items tossed into the waste basket. Effectively, users attempt to “score a goal” by tossing items into the waste basket within the confines of the scoring frame. For hockey, soccer or other games with a similar defined goal, a properly-dimensioned goal is clipped onto a standard-sized waste basket. For football, properly-dimensioned field goal posts are clipped onto a standard-sized waste basket. Other sports goals are likewise adapted to clip onto a standard-sized waste basket.

### BRIEF DESCRIPTION OF THE SEVERAL VIEWS OF THE DRAWING

FIG. 1. Front view of sample hockey goal. The black-lined portion represents the lip of the waste basket and does not form any part of the device.

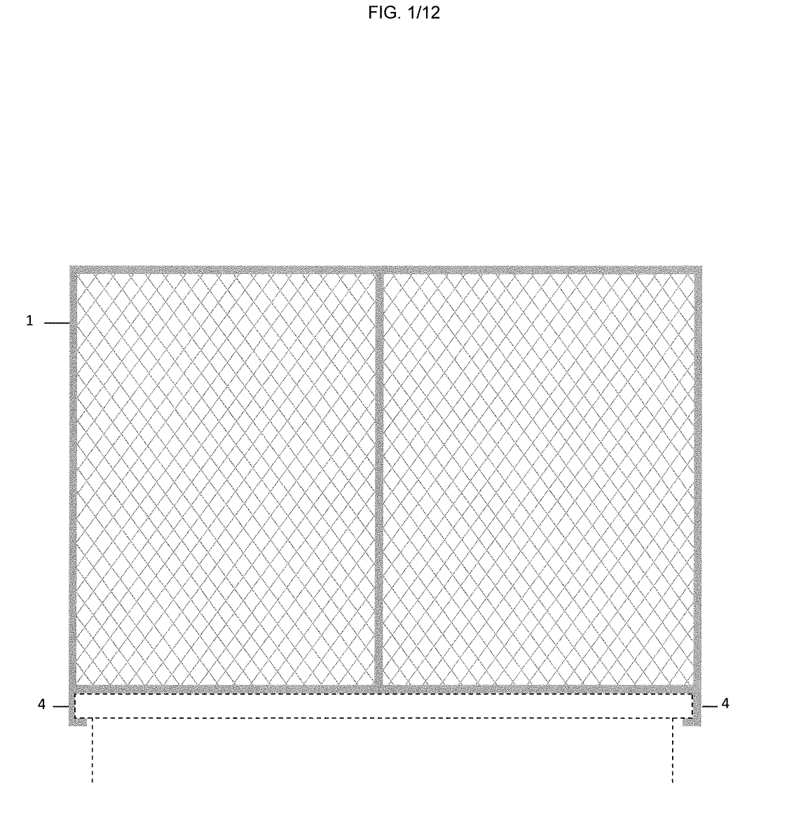

FIG. 2. Back view of sample hockey goal. The black-lined portion represents the lip of the waste basket and does not form any part of the device.

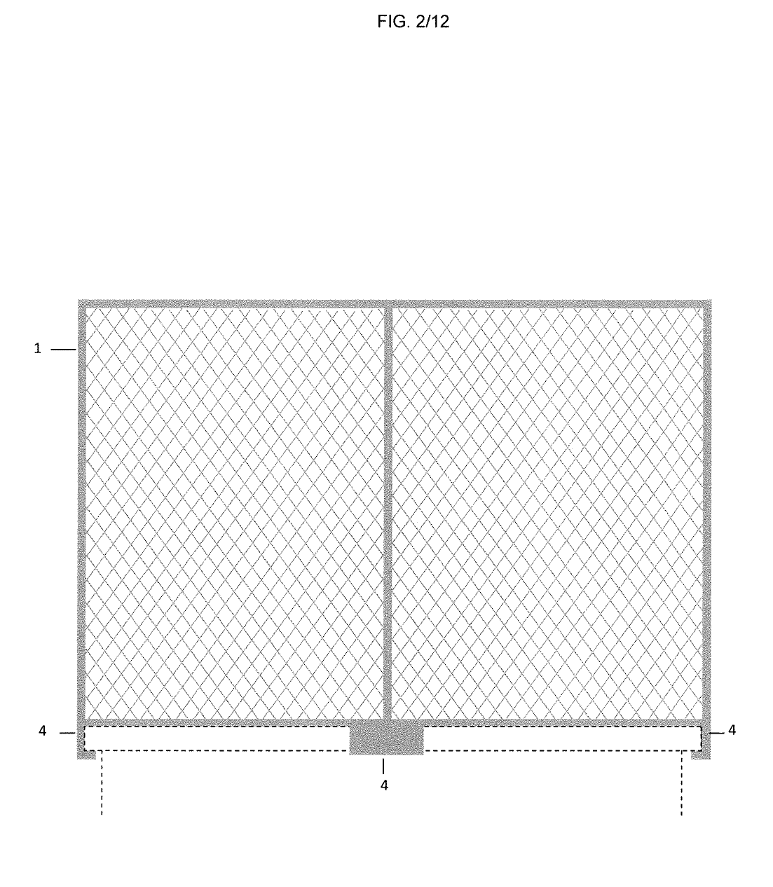

FIG. 3. Side view of sample hockey goal. The black-lined portion represents the lip of the waste basket and does not form any part of the device.

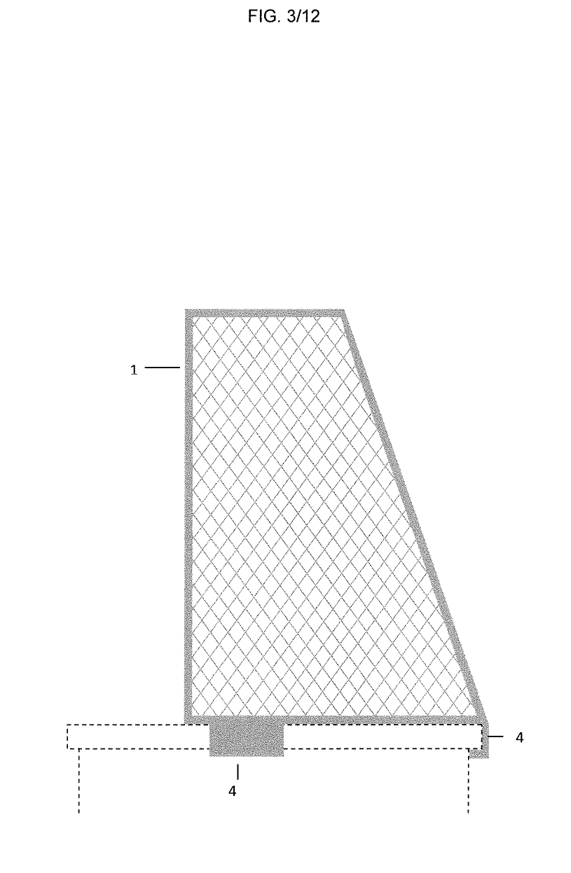

FIG. 4. Top view of sample hockey goal. The black-lined portion represents the lip of the waste basket and does not form any part of the device.

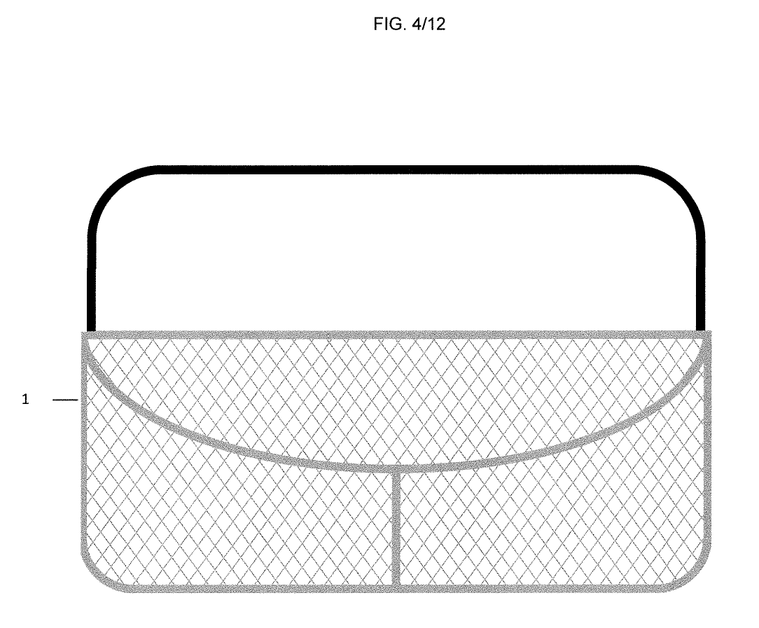

FIG. 5. Close-up view of the netting attachment points.

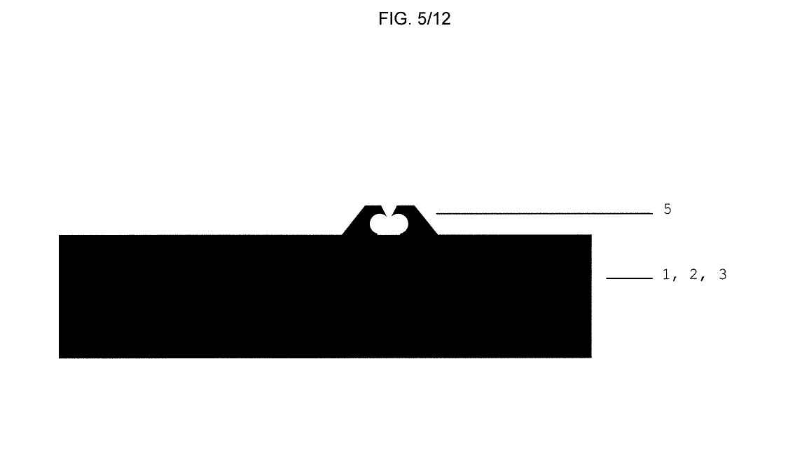

FIG. 6. Front view of sample soccer goal. The black-lined portion represents the lip of the waste basket and does not form any part of the device.

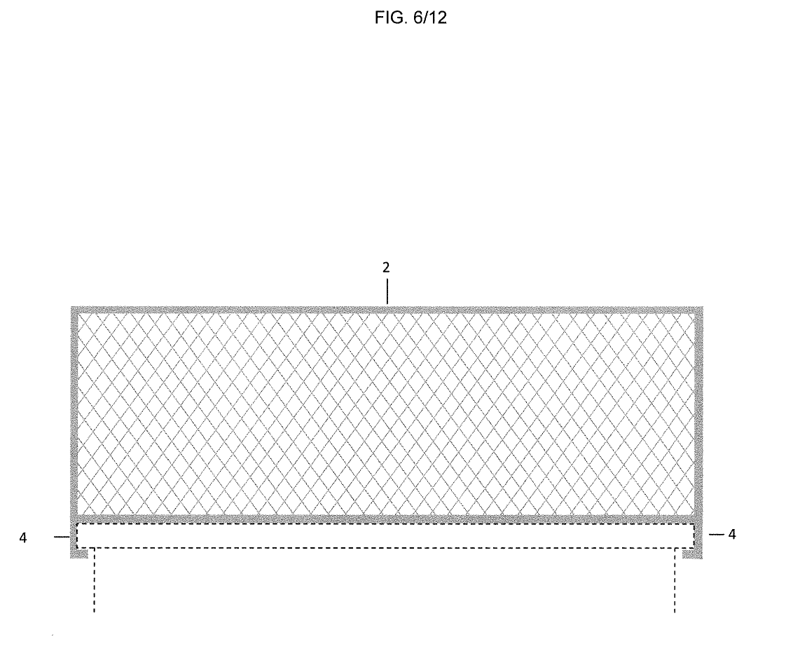

FIG. 7. Back view of sample soccer goal. The black-lined portion represents the lip of the waste basket and does not form any part of the device.

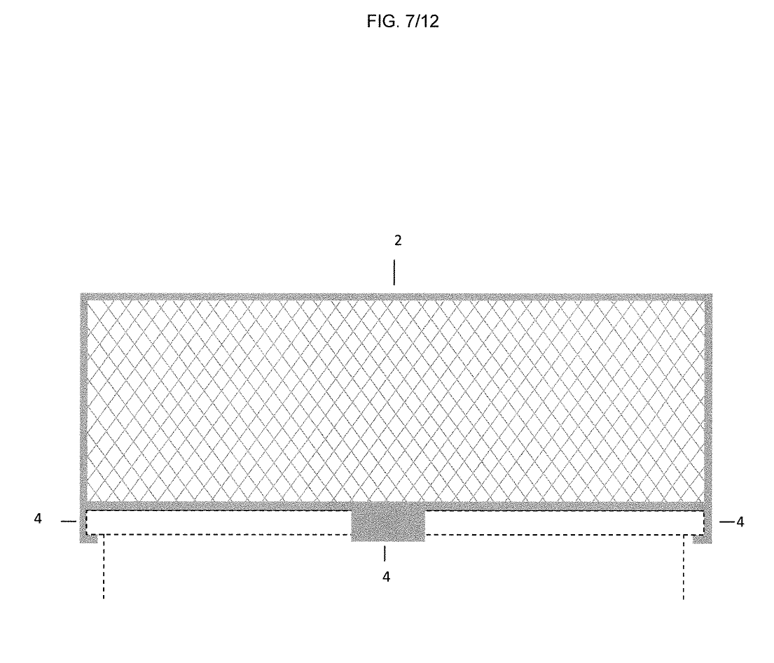

FIG. 8. Side view of sample soccer goal. The black-lined portion represents the lip of the waste basket and does not form any part of the device.

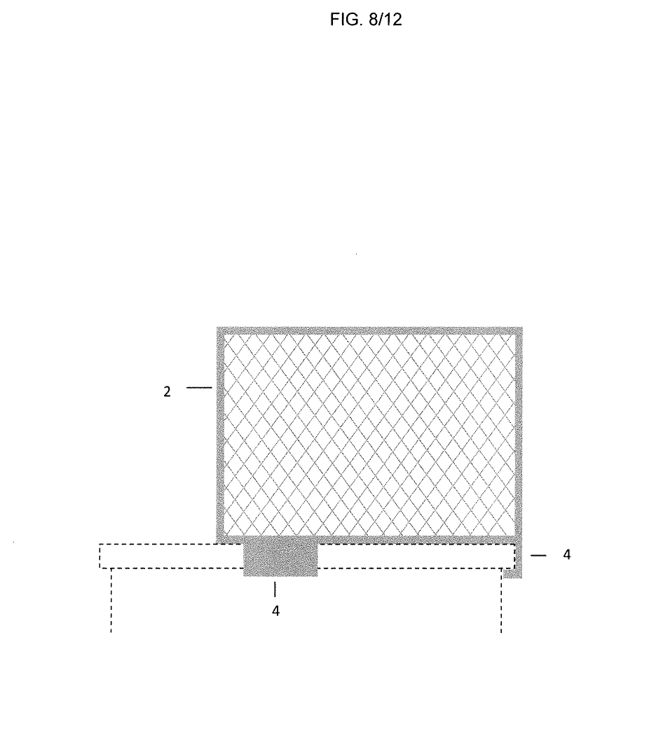

FIG. 9. Top view of sample soccer goal. The black-lined portion represents the lip of the waste basket and does not form any part of the device.

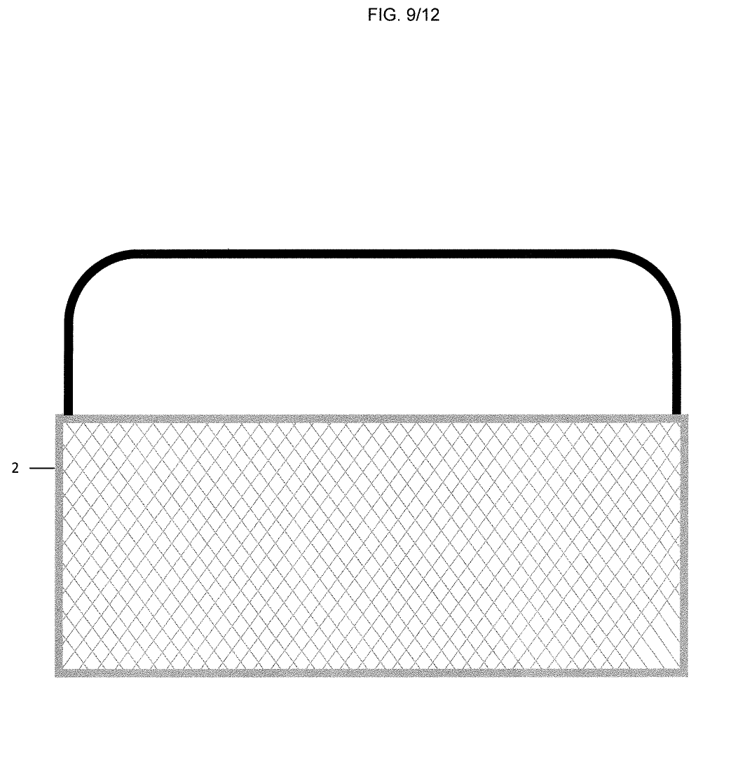

FIG. 10. Front view of sample football field goal posts. The black-lined portion represents the lip of the waste basket and does not form any part of the device.

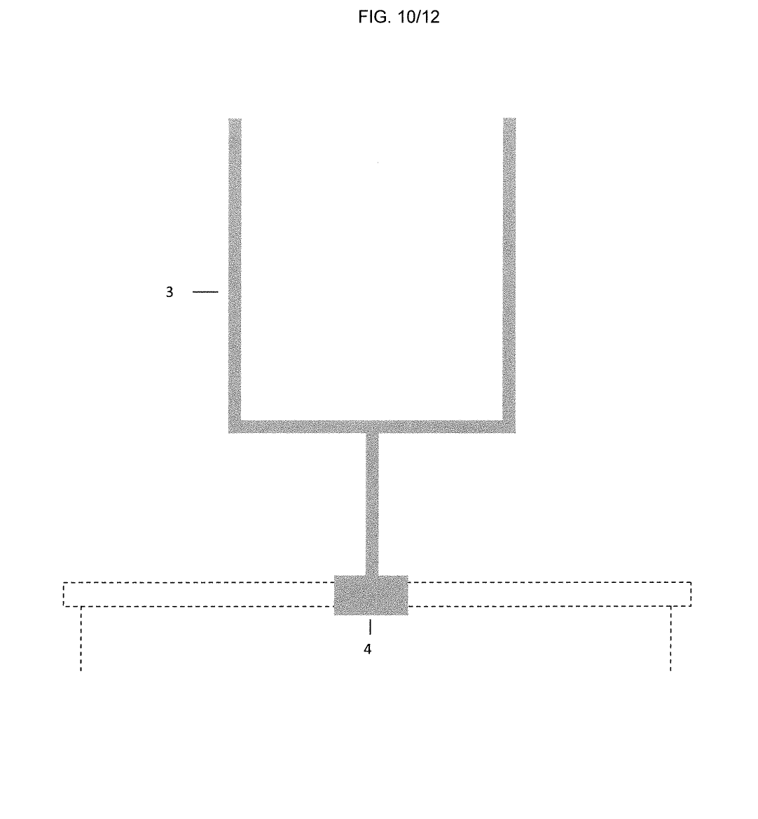

FIG. 11. Back view of sample football field goal posts. The black-lined portion represents the lip of the waste basket and does not form any part of the device.

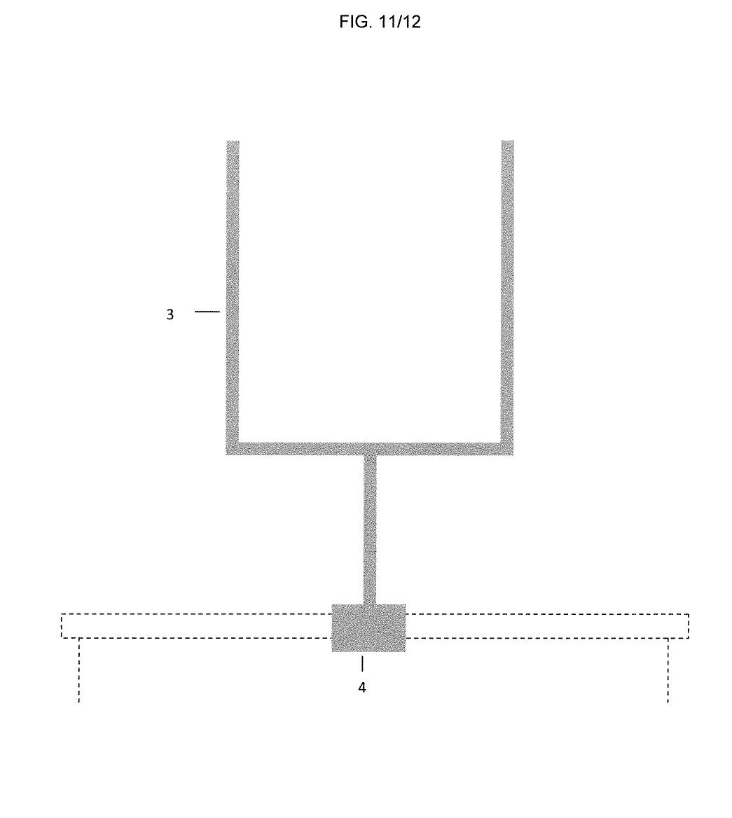

FIG. 11. Side view of sample football field goal posts. The black-lined portion represents the lip of the waste basket and does not form any part of the device.

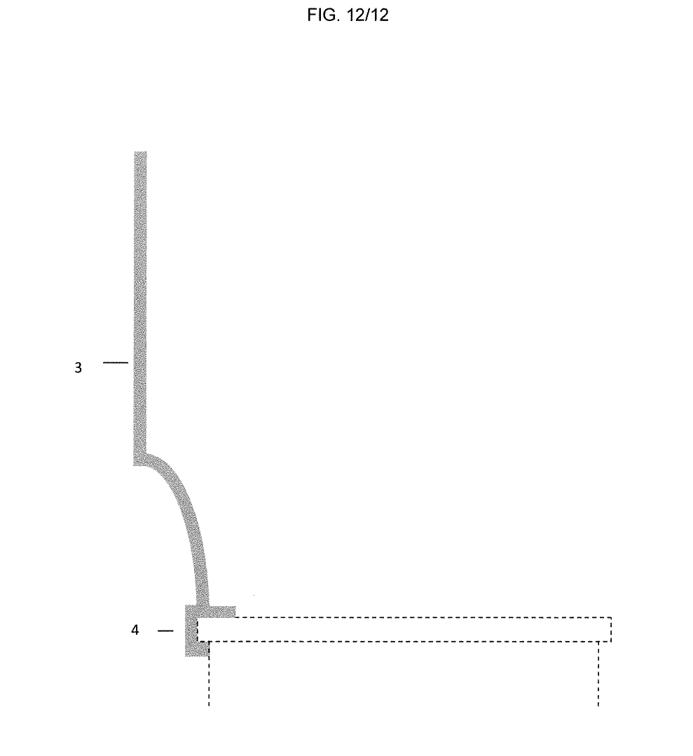

### DETAILED DESCRIPTION OF THE INVENTION

This device is designed to turn the job of tossing waste into a waste basket into a fun activity. The device is clipped onto a waste basket, preferably one of a standard size. The device is in the shape of a sports goal. For hockey, the device is in the shape of a hockey goal. For soccer, the device is in the shape of a soccer goal. For football, the device is in the shape of field goal posts. For other sports, the device is in the shape of the goal used in that sport.

For hockey, the device is constructed in the same dimensions as a conventional hockey goal, with a 3:2 width-to-height ratio. The frame (1) is made of a suitable material of sufficient strength so as to remain rigid and in place, even when struck by objects being tossed into the waste basket. Netting is used to enclose the targeted area.

For soccer, the device is constructed in the same dimensions as a conventional soccer net, with a 3:1 width-to-height ratio. The frame (2) is made of a suitable material of sufficient strength so as to remain rigid and in place, even when struck by objects being tossed into the waste basket. Netting is used to enclose the targeted area.

For football, the device is constructed in the same dimensions as conventional football field goal posts. The posts (3) are made of a suitable material of sufficient strength so as to remain rigid and in place, even when struck by objects being tossed into the waste basket.

The device may be altered in design to meet the dimensions of goals or nets for other sports.

Fastening devices (4) are used to affix the invention to a standard-sized waste basket. In its preferred embodiment, these fastening devices (4) allow the user to clip the device to the lip of a waste basket.

In its preferred embodiment, the device is designed to be affixed atop a standard 7-gallon waste basket, which can be found in any major office or home supply store.

The frame of the net is made of a rigid material, preferably plastic, though the net frame can also be formed out of other materials such as wood or metal.

The netting is a natural or synthetic fiber designed to prevent the passage through of waste tossed into the device.

The frame has small attachment points (5) to hold the netting in place. Once in place, the net provides a target for waste tossed into the waste basket.

1. A device to be attached to a container, comprising:
a. A frame in the dimensions of a sports goal;
b. A fastening mechanism to allow the device to be attached to a waste basket; and
c. Where the sports goal includes netting, netting secured around the outer edges of the frame.
The device in claim 1, where the sports goal is a hockey goal.
The device in claim 1, where the sports goal is a soccer goal.
The device in claim 1, where the sports goal is a set of football field goal posts.
The device of claim 1, where the netting is affixed to the frame by means of small clasps that form part of the frame.
The device in claim 1, where the fastening mechanism to secure the device to a waste basket is a plurality of clips that protrude below the lower edge of the device to secure the device to upper lip of the waste basket.
The device in claim 1, where two-sided sticky tape is used as the fastening mechanism to secure the device to the waste basket.
The device in claim 1, where the waste basket to which the device is attached is a 7-gallon waste basket.
The device in claim 1, where the waste basket to which the device is attached is a 3-gallon waste basket.
